(19) United States
(12) Patent Application Publication
(10) Pub. No.: US 2005/0136756 A1
(43) Pub. Date: Jun. 23, 2005

(54) Laminated article and method of manufacturing same

(76) Inventors: Larry F. Kocher, Canton, MI (US); Normand R. Marceau, Linden, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/744,728

(22) Filed: Dec. 23, 2003

(51) Int. Cl. B32B 27/04; B32B 17/04; B32B 17/02; B32B 5/02; B32B 5/26; B32B 27/32; B32B 27/12

(52) U.S. Cl. 442/35; 442/180; 442/394; 442/38; 442/41; 442/398; 442/149

(57) ABSTRACT

A laminated article includes an optional scrim material, a barrier film and a chopped fiberglass layer or a layer of fiberglass mat. The barrier film is extruded and the scrim material and the chopped fiberglass/fiberglass mat are applied to the barrier film while at least a portion of the barrier film is in a molten state. As a result, the method of the invention eliminates the need to heat the scrim/barrier film/fiberglass composite in an oven to activate the adhesive layers in the barrier film, thereby reducing time and cost associated with the manufacturing of the laminated article.

### BACKGROUND OF THE INVENTION

1. Field of the Invention

The present invention relates to a laminated article and method for forming the laminated article. More particularly, the present invention relates to a laminated article formed by extruding a polyethylene film and applying a layer of chopped fiberglass or a layer of fiberglass mat to the film while the film is in at least a partially molten state.

2. Description of the Related Art

The interior of a motor vehicle is constantly being improved upon by maximizing the strength and minimizing the weight and cost associated with each component incorporated therein.

One component in the interior of a motor vehicle that is undergoing a transformation is the headliner. The headliner is a large lining that extends over the top of the passenger compartment of the motor vehicle to cover the roof thereof. Typically, the headliner includes a chopped fiberglass laminate formed by feeding a continuous non-woven scrim of fiber material and a non-porous barrier film through a pair of nip rollers. Chopped fiberglass and adhesive are deposited on the moving barrier film and non-woven scrim that is then heated in an oven, passed through pressure nip rollers, cooled and then wound in roll form for transport and use.

A headliner composite may be formed by combining the fiberglass laminate with a foam layer on the fiberglass surface, and additional fiberglass layer is disposed on the opposite surface of the foam and a decorative fabric that may include a foam backing is placed on the exposed fiberglass surface. The headliner composite is then ready for molding. Unfortunately, many time-consuming and costly steps are involved in such conventional manufacturing processes.

### SUMMARY OF THE INVENTION

The inventor of the present invention has recognized these and other problem associated with conventional processes for the manufacture of a laminated article, such as a headliner, and has developed a laminated article and a method of manufacturing the laminated article that is less time-consuming and less costly. In one embodiment of the invention, a laminated article comprises a layer of film material and a layer of chopped fiberglass deposited on the layer of film material while at least a portion of the layer of film material is in a molten state. In an alternate embodiment, the laminated article comprises a layer of film material and a layer of fiberglass mat applied to the layer of film material while at least a portion of the layer of film material is in a molten state.

A method of manufacturing the laminated article is also disclosed. In one method of the invention, the method comprises the steps of:
extruding a layer of film material; and
depositing a first layer of chopped fiberglass on the layer of film material while at least a portion of the layer of film material is in a molten state.

In an alternate method of the invention, the method comprises the steps of:
extruding a layer of film material; and
depositing a first layer of fiberglass mat on the layer of film material while at least a portion of the layer of film material is in a molten state.

### BRIEF DESCRIPTION OF THE DRAWINGS

The present invention will now be described, by way of example, with reference to the accompanying drawings, in which:

FIG. 1 is a partial cross-sectional view of a laminated article constructed and arranged in accordance with an embodiment of the invention.

FIG. 2 is a schematic view of a method of manufacturing the laminated article of FIG. 1 according to the present invention.

FIG. 3 is a partial cross-sectional view of a laminated article constructed and arranged in accordance with an alternate embodiment of the invention.

FIG. 4 is a schematic view of a method of manufacturing the laminated article of FIG. 3 according to the present invention.

FIG. 5 is a partial sectional view of a headliner incorporating the laminated article of the invention.

FIG. 6 is a partial cross-sectional view of the headliner of FIG. 5 when the headliner incorporating the laminated article of the invention is being molded.

### DETAILED DESCRIPTION OF THE INVENTION

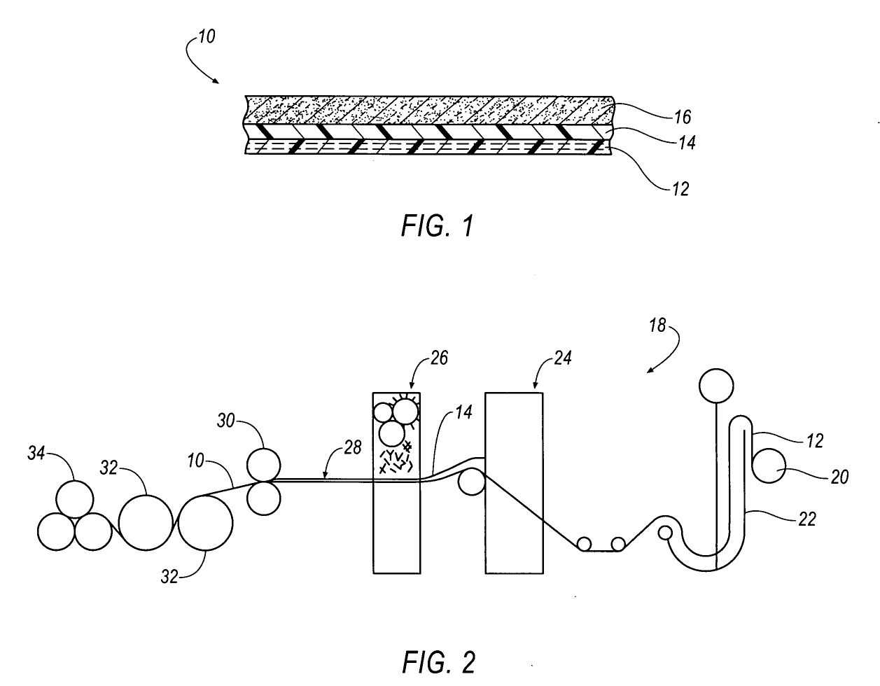

Referring to FIG. 1, a laminated article 10 is generally shown according to an embodiment of the invention. The laminated article 10 comprises an optional scrim material 12, a barrier film 14 and a chopped fiberglass layer 16. The laminated article 10 may be used, for example, as a headliner for a vehicle (not shown). When the laminated article 10 used as a headliner, the scrim material 12 will be the back surface of the headliner adjacent to the metal roof (not shown).

The scrim material 12 may be, for example, a nonwoven scrim material formed of a spunbond polyester fiber and has a weight between about 0.50-1.75 oz/yd (17-60 g/m). Preferably, the scrim material 12 has a weight between about 0.8-1.2 oz/yd (27-41 g/m) and is 100% polyethylene terephthalate (generally referred to as polyester or PET) fiber. In the exemplary embodiment, the scrim material 12 is a 100% polyester spunbond fiber weighing 1.00 oz/yd (34 g/m).

The barrier film 14 is formed of a thermoplastic film that may be formed of one or more layers. There are a wide variety of such barrier films available which are suitable for use in laminated article 10. A particular film chosen will depend on the headliner manufacturer's tool and the molding conditions, such as tool temperature and dwell time. The barrier film 14 may be a polyolefin film or may be a blend chemistry and can be formed of a single or multilayer structure. As noted, a wide selection of barrier films is suitable. Specific examples include Dow Integral 925 film that is a tri-layer film having a core layer heat stable up to about 165° C. (330° F.) and having outer polyethylene adhesive layers that are heat activated at temperatures of about 127° C. (260° F.).

The fiberglass layer 16 is formed by depositing chopped fiberglass on the exposed surface of the barrier film 14. The fiberglass applied to barrier film 14 is chopped to provide a range of between about 30-200 g/m of fiberglass with strands having a length between 1.0 and 4.0 inches. Preferably, the length of the chopped rovings is about 2.0 inches. Chopped glass fibers are applied to the barrier film 14 in a random fashion and may be combined with an anti-static chemical sizing agent to reduce static buildup at the glass chopper.

FIG. 2 illustrates the process steps and an apparatus 18 utilized to fabricate the laminated article 10. In the apparatus 18, the scrim material 12, such as a nonwoven scrim, is wound on a scrim roll 20 at a scray 22 is fed under a film extruder 24. The scrim material 12 is optional. The film extruder 24 extrudes a sheet of the barrier film 14 over the scrim material 12 while the barrier film 14 is in a molten state. The temperature at which the barrier film 14 is in a molten state may vary on the type of material used for the barrier film 14. For example, when using the tri-layer Dow Integral 925 film, which has a core layer heat stable up to about 165° C. (330° F.) and has outer polyethylene adhesive layers that are heat activated at temperatures of about 127° C. (260° F.), as the barrier film 14, the temperature at which the barrier film 14 is extruded is between about 127° C. (260° F.) to about 165° C. (330° F.). When extruded between these temperatures, at least a portion of the barrier film 14 is in a molten state and the adhesive layers of the barrier film 14 are heat activated.

While the barrier film 14 is still in the molten state, the barrier film 14 is fed below a fiberglass chopper dispenser 26 where chopped fiberglass in the desired quantity is deposited on the exposed surface of the barrier film 14 to form a fiberglass/barrier film/scrim composite 28. Preferably, the deposition of the chopped fiberglass onto the exposed surface occurs at a distance of a few inches to a few feet from the extruder 24. It will be appreciated that the scrim material 12 and the chopped fiberglass layer 16 can be applied to the barrier film 14 at approximately the same time, rather than in subsequent steps, to ensure that the barrier film 14 is still in the molten state. Because the adhesive layers of the barrier film 14 are activated when the scrim material 12 and the chopped fiberglass layer 16 are applied, the requirement to heat the composite 28 in an oven, for example, to activate the adhesive layers is eliminated.

The composite 28 is laminated at a nip roller 30 to form the laminated article 10. The nip roller 30 is maintained at a temperature just below room temperature and applies a downward pressure of between about 10-80 lbs/in to the composite 28. Preferably, between about 30-40 lbs/in pressure is applied, and most preferably about 20 lbs/into form the laminated article 10. The actual pressure depends on the amount of fiberglass added at the fiberglass chopper 26 and the thickness deposited on the barrier film 14.

The laminated article 10 may then be further cooled at one or more cooling rollers 32 that are maintained below room temperature. The cooling rollers 32 further cool the laminated article 10 and provide a desired amount of tension between the cooling rollers 32 and a final batch roller 34 where the laminated article 10 is wound.

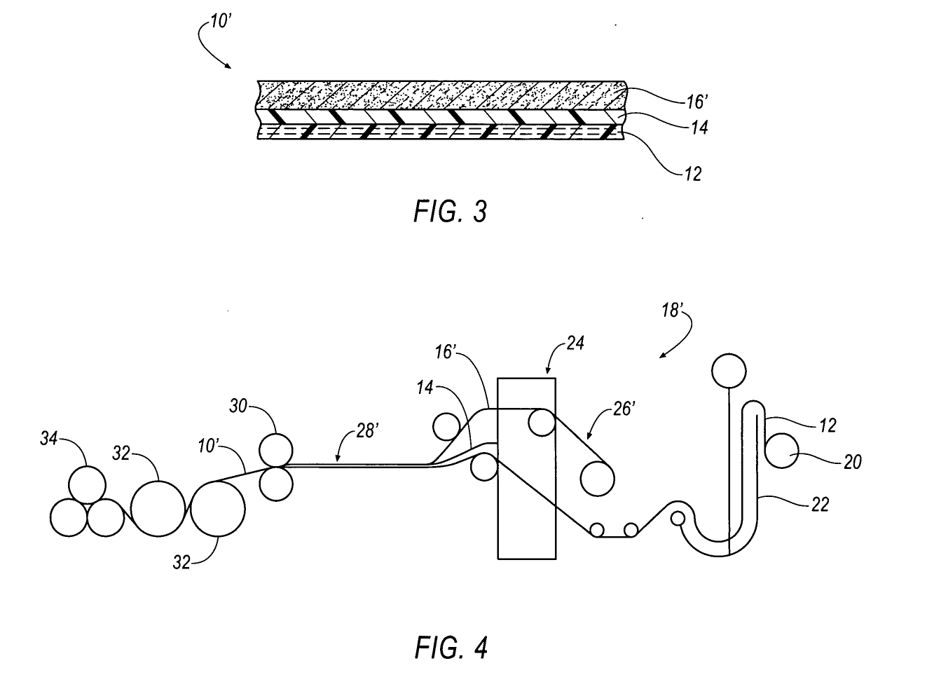

Referring now to FIG. 3, an alternate embodiment of a laminated article 10′ of the invention is shown. The laminated article 10′ is identical in construction as the laminated article 10, except that the chopped fiberglass layer 16 of the laminated article 10 is replaced with a fiberglass mat 16′.

FIG. 4 illustrates the process steps and an apparatus 18′ utilized to fabricate the laminated article 10′. In the apparatus 18′, the scrim material 12, such as a nonwoven scrim, is wound on a scrim roll 20 at a scray 22 is fed under a film extruder 24. The scrim material 12 is optional. The film extruder 24 extrudes a sheet of the barrier film 14 over the scrim material 12 while the barrier film 14 is in a molten state, whereby the adhesive layers of the barrier film 14 are heat activated.

While the barrier film 14 is still in the molten state, the barrier film 14 is fed below a fiberglass mat dispenser 26′ where the fiberglass mat 16′ is applied to the exposed surface of the barrier film 14 to form a fiberglass/barrier film/scrim composite 28′. Preferably, the application of the fiberglass mat 16′ to the exposed surface occurs at a distance of a few inches to a few feet from the extruder 24. It will be appreciated that the scrim material 12 and the fiberglass mat 16′ can be applied to the barrier film 14 at approximately the same time, rather than in subsequent steps, to ensure that the barrier film 14 is still in the molten state. Because the adhesive layers of the barrier film 14 are activated when the scrim material 12 and the fiberglass mat 16′ are applied, the requirement to heat the composite 28′ in an oven, for example, to activate the adhesive layers is eliminated.

The composite 28′ is laminated at the nip roller 30 to form the laminated article 10′. The laminated article 10′ may then be further cooled at one or more cooling rollers 32 that are maintained below room temperature. The laminated article 10′ is wound at the final batch roller 34.

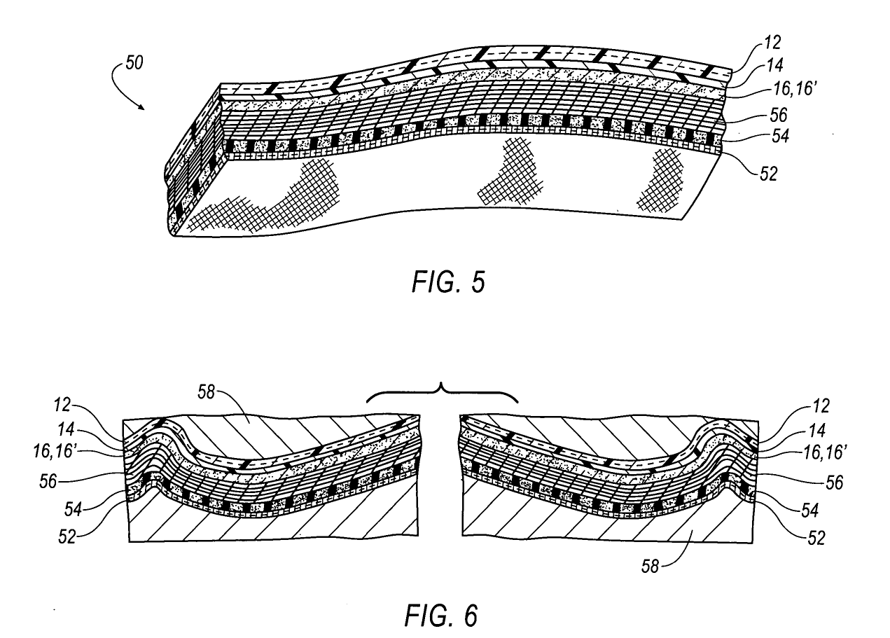

As mentioned above, the laminated article 10, 10′ may be used in a headliner of a vehicle. Referring now to FIG. 5, a headliner 50 includes an outer layer of a vinyl or decorative fabric 52 that may be backed with a layer of thin foam to mask surface irregularities. The decorative fabric 52 is adhered to an outer surface of a foam core 56 that may be impregnated with a liquid resin, such as an isocyanate as is well-known in the art, and a second layer of chopped fiberglass 54 therebetween. The components are assembled in order described above and placed within a mold 58 and closed, as shown in FIG. 6.

The laminated article 10, 10′ manufactured in accordance with the process illustrated in FIGS. 2 and 4 provides significant advantages over conventional methods. For example, conventional laminated articles require the use of an adhesive applied onto the chopped fiberglass or fiberglass mat, and then heating the composite in an oven to active the adhesive. By contrast, the method of the invention eliminates the need of adding an adhesive to the chopped fiberglass or fiberglass mat and heating the adhesive to bind the composite together, thereby reducing the time and cost of manufacturing the laminated article.

Some laminated articles require the use of a thermoset resin to bind together the various layers of the headliner assembly. As a result, the composite forming the laminated article must be heated in order for the resin to properly bind the layers of the laminated article. Additionally, conventional laminated articles require an additional step of pre-mixing the thermoset resin with a catalyst before applying the mixture to the composite. By applying the optional scrim material and the chopped fiberglass/fiberglass mat while at least a portion of the barrier film is in a molten state, the method of the invention eliminates such steps, thereby reducing the time and cost of manufacturing the laminated article.

It should be noted that while the present invention is directed towards a headliner assembly, the present invention may be applied to various components within the vehicle, including, for example, a door trim, or a luggage trim, or the like.

While the invention has been specifically described in connection with certain specific embodiments thereof, it is to be understood that this is by way of illustration and not of limitation, and the scope of the appended claims should be construed as broadly as the prior art will permit.

1. A laminated article, comprising:
a layer of film material; and
a layer of chopped fiberglass deposited on said layer of film material while at least a portion of said layer of film material is in a molten state.

2. The laminated article of claim 1, wherein said layer of film material comprises polyethylene material.

3. The laminated article of claim 1, wherein said layer of film material comprises a tri-layer material including a core material disposed between layers of adhesive material.

4. The laminated article of claim 1, wherein said layer of film material has a temperature of between about 250° F. and about 300° F. when said first layer of chopped fiberglass is deposited on said layer of film material.

5. The laminated article of claim 1, further including a scrim material applied to an opposite side of said layer of film material.

6. A laminated article, comprising:
a layer of film material; and
a layer of fiberglass mat applied to said layer of film material while at least a portion of said layer of film material is in a molten state.

7. The laminated article of claim 6, wherein said layer of film material comprises polyethylene material.

8. The laminated article of claim 6, wherein said layer of film material comprises a tri-layer material including a core material disposed between layers of adhesive material.

9. The laminated article of claim 6, wherein said layer of film material has a temperature of between about 250° F. and about 300° F. when said first layer of chopped fiberglass is deposited on said layer of film material.

10. The laminated article of claim 6, further including a scrim material applied to an opposite side of said layer of film material.

11. A method of manufacturing a laminated article, comprising the steps of:
extruding a layer of film material; and
depositing a first layer of chopped fiberglass on said layer of film material while at least a portion of said layer of film material is in a molten state.

12. The method of claim 11, wherein said layer of film material comprises polyethylene material.

13. The method of claim 11, wherein said layer of film material comprises a tri-layer material including a core material disposed between layers of adhesive material.

14. The method of claim 11, wherein said layer of film material has a temperature of between about 250° F. and about 300° F. when said first layer of chopped fiberglass is deposited on said layer of film material.

15. The method of claim 11, further including the step of applying a scrim material to an opposite side of said layer of film material.

16. A method of manufacturing a laminated article, comprising the steps of:
extruding a layer of film material; and
depositing a first layer of fiberglass mat on said layer of film material while at least a portion of said layer of film material is in a molten state.

17. The method of claim 16, wherein said layer of film material comprises polyethylene material.

18. The method of claim 16, wherein said layer of film material comprises a tri-layer material including a core material disposed between layers of adhesive material.

19. The method of claim 16, wherein said layer of film material has a temperature of between about 250° F. and about 300° F. when said first layer of chopped fiberglass is deposited on said layer of film material.

20. The method of claim 16, further including the step of applying a scrim material to an opposite side of said layer of film material.
